(19) United States
(12) Patent Application Publication
(10) Pub. No.: US 2026/0116155 A1
(43) Pub. Date: Apr. 30, 2026

(54) VEHICLE DEHUMIDIFICATION SYSTEM

(71) Applicant: MAHLE International GmbH, Stuttgart (DE)

(72) Inventors: Akash Patil, Pune (IN); Swapnil Puranik, Pune (IN); Ruifei Xiang, Tokyo (JP)

(21) Appl. No.: 18/931,763

(22) Filed: Oct. 30, 2024

(51) Int. Cl. B60H 3/02; B60H 1/00

(52) U.S. Cl. CPC B60H 3/024; B60H 1/00785

(57) ABSTRACT

An air treatment system is provided that includes a housing with an air inlet, a dehumidification component, a first outlet and a second outlet each disposed to receive air that has flowed past the dehumidification component. The first outlet is aligned to direct air flowing therethrough to be maintained within a vehicle that includes the housing, and the second outlet is aligned to direct air flowing therethrough out of the vehicle. The dehumidification component includes first and second portions that sequentially receive electric current such that in a first operational setting the first portion receives an influx of heat directed thereto and the second portion does not, and in a second operational setting the second portion receives an influx of heat directed thereto and the first portion does not. A valve that directs air received from the dehumidification component to either the first or the second outlet.

### BACKGROUND OF THE INVENTION

This application relates to an HVAC system for a vehicle and particularly to an HVAC system for a vehicle that is capable of operating under electrical power.

### SUMMARY OF THE INVENTION

A first representative embodiment of the disclosure is provided. The embodiment includes an air treatment system. The air treatment system includes a housing with an air inlet, a dehumidification component, a first outlet and a second outlet each disposed to receive air that has flowed past the dehumidification component, wherein the first outlet is aligned to direct air flowing therethrough to be maintained within a vehicle that includes the housing and ultimately to a passenger compartment for the vehicle, and the second outlet is aligned to direct air flowing therethrough out of the vehicle and not into the passenger compartment. The dehumidification component is configured to receive electric current during operation. The dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon. A valve that directs air received from the dehumidification component to either the first or the second outlet.

Another representative embodiment of the disclosure is provided. The embodiment includes an air treatment for use within a sealed compartment. The system includes a sealed compartment that is configured to receive one or more batteries therein. A housing is disposed within the sealed compartment, the housing comprising an air inlet, a dehumidification component, a first outlet and a second outlet each disposed to receive air that has flowed past the dehumidification component, wherein the first outlet is aligned to direct air flowing therethrough to be maintained within the sealed compartment that includes the housing, and the second outlet is aligned to direct air flowing therethrough out of sealed compartment. The dehumidification component is configured to receive electric current during operation. The dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon. A valve that directs air received from the dehumidification component to either the first or the second outlet.

Other representative embodiments of the disclosure are provided and include the structure describe in one or more of Representative Paragraphs 1-43 provided at the end of this specification of this application.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an air treatment system for removing moisture content from air that flows therethrough.

FIG. 1A is the view of FIG. 1 with an inlet fan removed.

FIG. 2 is a rear perspective view of the air treatment system of FIG. 1.

FIG. 3 is an exploded view of the air treatment system of FIG. 1.

FIG. 4 is perspective cross-sectional view of the air treatment system of FIG. 1, across the cutting plate A—A of FIG. 1A, with the air treatment system in a first operation setting.

FIG. 5 top view of the cross-section of FIG. 4, with the air treatment system in the first operational setting.

FIG. 6 is the view of FIG. 5 with the air treatment system in a second operational setting.

FIG. 7 is a perspective view of a dehumidification component usable with the air treatment system of FIG. 1, where the dehumidification component is a dual section desiccant component.

FIG. 8 is a schematic view of a use of the air treatment system of FIG. 1 within a sealed battery compartment with a vehicle.

FIG. 9 is a cross-sectional view of an outlet housing of the system of FIG. 8 within the valve in the closed position to prevent air flow into and out of the sealed battery compartment.

FIG. 9A is the view of FIG. 9 with the valve in an open position to allow air flow from outside to flow into the sealed battery compartment and to allow air from within the sealed battery compartment to flow outside of the sealed battery compartment and to the surrounding area.

### DETAILED DESCRIPTION OF THE INVENTION

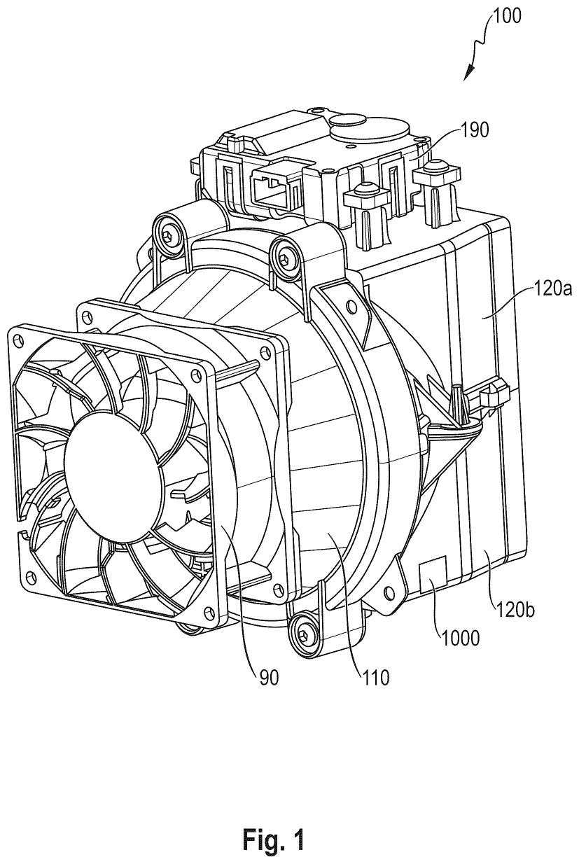

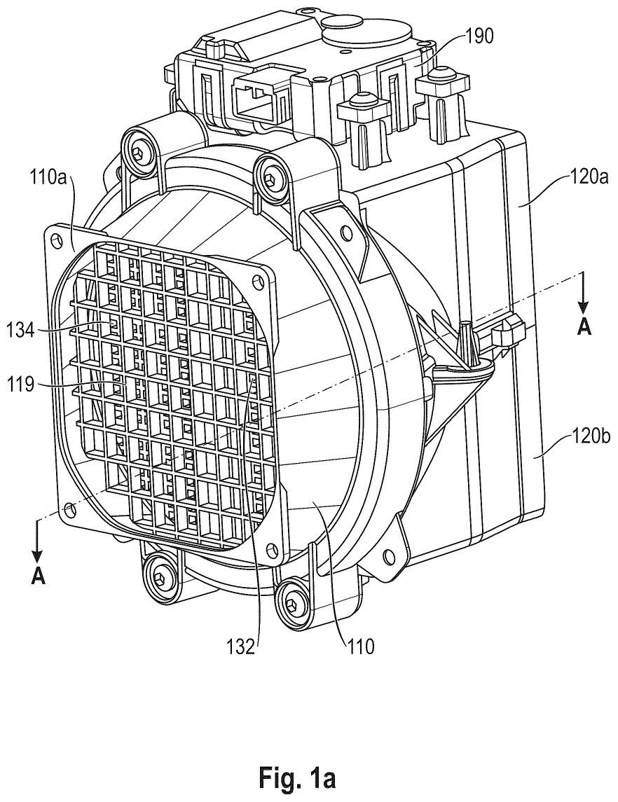

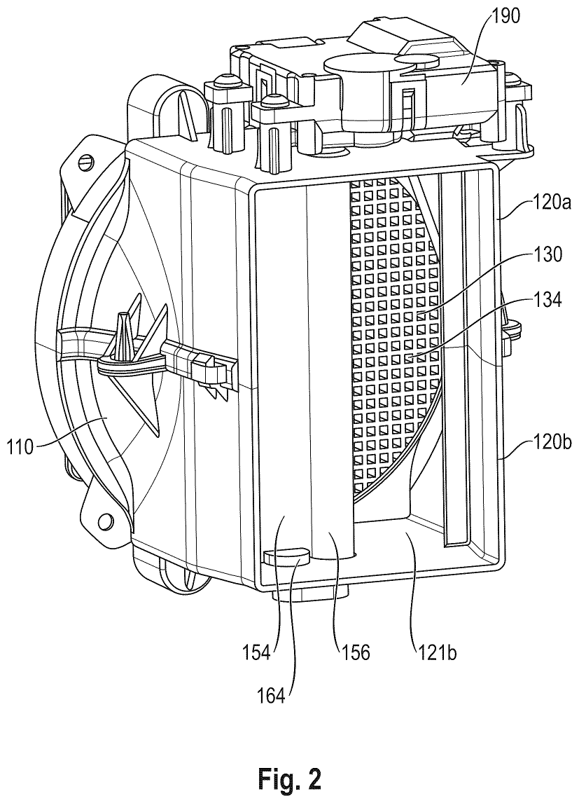

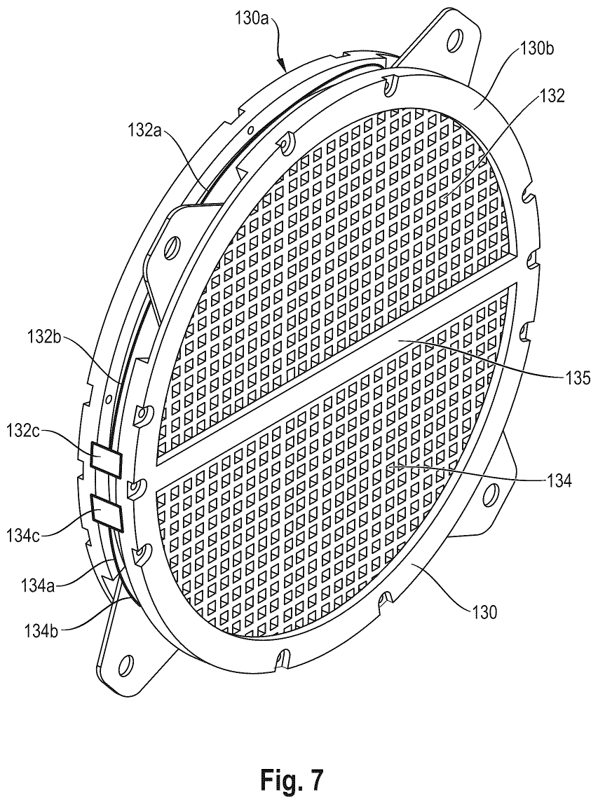

Turning now to FIGS. 1-7 an air treatment system 100 for a vehicle is provided. The air treatment system 100 is configured to remove moisture from that air that is received therein and expel dryer air from a first outlet 121b thereof and expel liquid and/or humid air from a second outlet 180. The air treatment system 100 may be positioned within a vehicle in several different positions, including upstream of air inlet housing for an HVAC system, and specifically an inlet into the air inlet housing that is positioned to receive air from a passenger compartment of a vehicle (i.e. “recirc air”). The air treatment system 100 may alternatively be included within an HVAC system, i.e. between an air inlet housing and a blower of the HVAC system.

Alternatively, the air treatment system 100 may be positioned within other parts of a vehicle that aren't related to a vehicle's HVAC system, such as proximate to a an air flow path across a battery for an electric vehicle, or within an enclosed sealed space with one or more batteries, such then when operating moisture within the air within the enclosed space can be urged out of the air treatment system 100 and out of the enclosure.

For the sake of brevity, the air treatment system 100 will be discussed in detail below when positioned within a vehicle such that the air that flows out of the first outlet 121b flows to an air inlet module of an HVAC system for a vehicle, and such that the air that enters the air treatment system 100 is recirc air that has flowed from the passenger compartment of the vehicle. One of ordinary skill in that art with a thorough review and understanding of this specification and figures will readily understand how the air treatment system 100 may be implemented within other positions within a vehicle, such as within an HVAC system between the air inlet housing and the HVAC fan, or such as disposed to remove humidity/water vapor from other parts of a vehicle such as proximate to a battery of an electric vehicle—and the construction of the system would be the same, or with readily understood changes. For example, in embodiments where the air treatment system 100 would be provided within an HVAC system, housing 110 would be constructed to be positioned within the envelope of the HVAC system (as typically driven by the space available provided by the vehicle manufacturer) and the system maybe sized and positioned to either receive all of the air that flows to the HVAC blower, or a percentage of the air that flows to the HVAC blower, or to be positioned such that a large percentage of recirc air (i.e. from the passenger compartment) that flows toward the fan flows through the air treatment system 100, but none or a small percentage of outside air that flows toward the HVAC blower flows through the system 100. This embodiment may be accomplished by maintain the recirc and outside air flows within the HVAC system separated until they pass through or bypass the air treatment system 100, or by the positioning the air treatment system 100 in a position within the HVAC system where the recirc air received typically will flow through the air treatment system, but in a position where outside air (that enters the HVAC inlet housing at a different location from the position of recirc air entry into the HVAC inlet housing) does not flow through the air treatment system 100.

The air treatment system 100 may be configured to be used with a vehicle, such as a passenger vehicle, to provide for moisture removal from air that flows toward and into a vehicle HVAC system. In some embodiments, the air treatment system 100 is particularly suited for electrical vehicles that are powered (both for movement of the vehicle and for the other loads of the vehicle (i.e. climate control, infotainment, window operation, and the like)) from current drawn from a rechargeable battery, or for hybrid vehicles where the vehicle's propulsion can be selectively powered from an internal combustion engine or with electrical power from an on board battery. In other embodiments, the air treatment system 100 may be implemented in other vehicles or machines that include passenger compartments, or that use air flow therein for various purposes, particularly for vehicles or machines that can operate with electric power but do not have a constant access to electrical power. For example, the air treatment system 100 may be used with the HVAC systems of farm equipment, large trucks (e.g. dump trucks, cement trucks), cranes, material handling equipment, boats, trains, aircraft, or the like. For the sake of brevity this specification is specifically directed to passenger vehicles but the air intake system 100 could be readily adapted for other vehicles or machines as will be readily understood to those of skill in the art with a thorough review and understanding of this specification and figures.

The air treatment system 100 is configured to remove moisture/water vapor from air that flows through the housing 110. In some embodiments, the system may be configured to remove about 85 g of water/hour during operation, while one of ordinary skill the art will readily understand with reference to the subject specification and figures that the capability of water removal is a function of the size, and type of components used and the possible air flow (which may be the amount of forced air) therethrough, and that system may be designed for other continuous water removal targets with only routine optimization when following the disclosure of this application. The water removal capability of the system is a function of the humidity percentage of the air that flows into the housing 100, such that for the same design and operational parameters, air a higher humidity percentage will allow for more removal of water than air with a lower humidity percentage for a given temperature. The performance of the system is also based upon air inlet temperature. For designs that are configured to remove about 85 g of water per hour, the air flow through the system may be within the range of about 40-100 m3 per hour.

The air treatment system 100 is beneficial for hybrid vehicles operating in battery mode or for fully electric vehicles, because it allows for HVAC operation entirely from, or with a significant percentage of, air that flows into the HVAC system from the passenger compartment. In this circumstance, particularly during operation when the outside temperature is significantly lower than the desired temperature within the passenger compartment, allowing the HVAC system to receive air from the passenger compartment (rather than the HVAC system receiving air from outside of the vehicle) minimizes the electrical power needed to heat the air that flows through the HVAC system before leaving the HVAC system - either flowing into the passenger compartment or being used for a defrost or demist system. As is well experienced in the art, during vehicle operation when the passenger compartment temperature is significantly higher than the outside temperature, it is often problematic for an HVAC system to receive air from the passenger compartment, because the air within the passenger compartment - particularly after the vehicle has been operated for a while, has a much higher humidity than the outside air due to the humidity added to the air by the passenger occupants. Operation of the HVAC system with intake air with a high relative humidity causes windows to fog due to the outside temperature (transferred through the windows) reaching or extending below the dew point of the air. The air treatment system 100 disclosed herein is beneficial for operation of vehicle (particularly in the cold weather months) because the air treatment system 100 removes water vapor from the intake air (when received from the passenger compartment), which increases the dew point of the air that returns to the passenger compartment from the HVAC system—thereby reducing or eliminating the tendency of window fogging and also eliminating the need for the HVAC system to operate to inject significant heat to the air flowing through the HVAC system before flowing the passenger compartment—which, as discussed above, requires significant electrical power to operate the heat pump system and in some situations electric heaters downstream of the heat pump heater.

In some embodiments, a fan 90 may be provided upon an inlet 110a of the air treatment system 100 (FIG. 1). The fan 90 is provided to, when operating, urge air to enter into the housing 110 and flow through the system, such that the system may remove a portion of moisture or humidity within the air that flows through the housing 110. In embodiments where the system 100 is not included within an HVAC system, the fan 90 when operating urges a substantial mass flow rate of air through the housing 110, and significantly greater mass flow rate then will flow through the housing when the fan 90 is not operating. Accordingly, the presence of a fan, that can be operated when it is determined to be necessary (such as during times of large recirc air flows into an HVAC system, or during cold whether vehicle operation when the passenger compartment is maintained at a temperature higher than the temperature outside the vehicle), the air treatment system 100 may be beneficially used to remove moisture or humidity from the recirc air that enters into the HVAC system. Alternatively, during operation of the vehicle during warm weather—the recirc air may not have a higher relative humidity than the outside air and therefore the removal of moisture/humidity is not as important. In this circumstance, the fan 90 may not be operated to minimize the air that flows through the air treatment system.

In some embodiments, a valve may be provided at the inlet 110a of the housing, such as before the grate 119 depicted in FIG. 1A. The valve may be operable by an HVAC controller or another controller within the vehicle to either allow or prevent air flow into the inlet 110a of the housing 110, and may be operable, for example, to allow air flow into the inlet when the passenger compartment actual or desired temperature is higher than a temperature outside of the vehicle, and specifically more than a certain threshold higher (i.e. the passenger compartment temperature is 10 degrees F or more higher than the outside temperature).

The air treatment system 100 is depicted in FIGS. 1-7. The air treatment system 100 has a housing 110 that supports the components within the system and provides structure for the system to be mounted as desired, either within an HVAC system, or independent from the HVAC system as discussed above. The air treatment system 100 includes a dehumidifying component 130, flow valve 150 and first and second outlets 121b, 180. The first outlet 121b is an outlet where air that flows through the housing 110 flows out of the system, after flowing past the dehumidifying component 130. The second outlet 180 is an outlet where moisture (which may be liquid or air with a very high moisture content, or a combination of the two) flows out of the housing.

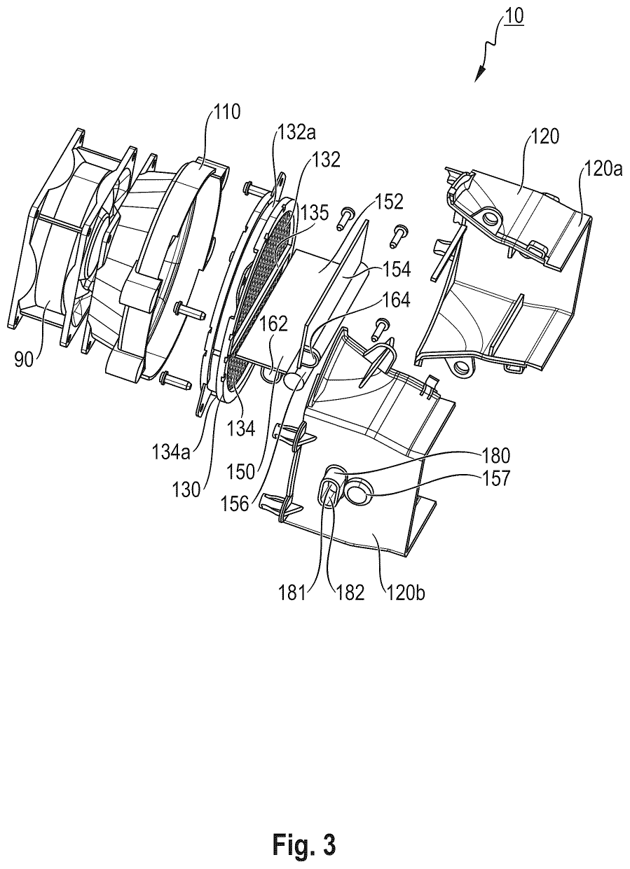

The housing 110 may be arranged such that the first outlet 121b is aligned such that air flows through the inlet 110a, through the dehumidifying component 130 and through the first outlet 121a along a straight line. The term “straight line” as used herein means an exact straight line (i.e. along or parallel to line 3001 shown schematically in FIG. 4), as well as a path that is generally straight but allows for some internal turns or curves but such the air approaches the inlet 110a parallel to a line 3001 that extends from the inlet 110a and to the outlet 121b, or in a direction that includes a substantial vector component (3002x) that is parallel to the line 3001, and that the path through the outlet is either parallel to the line 3001 or includes a substantial vector component (3003x) that is parallel to the line 3001. With reference to FIG. 4, for example, air that enters the inlet 110a along vector 3002 and exits the outlet 121b at vector 3003 (that are each at acute angles with respect to line 3001) would be flowing along a “straight line” because the vector components 3002x and 3003x are substantial (i.e. dominant to determine the direction of the vector). The air that moves within the housing would still flow along a straight line if the inlets and outlet flows are include substantial vector components that are parallel to the line 3001.

The second outlet 180 is arranged to expel flow through in a direction that is perpendicular to the straight line (3001) of flow through the housing 110 and to the first outlet 121b. The term perpendicular in context includes exactly perpendicular as well as substantially perpendicular in situations where air flow through the first outlet 121b is not parallel to the typical straight line of flow. In some embodiments, a line that extends through the second outlet 180 may be parallel to a plane 2001 that extends through an outlet surface 130b of the dehumidifying component 130. The housing 110 is configured with the first and second outlets 121b, 180 that urge flow in perpendicular directions to each other, such that the housing 110 may be positioned such that the flow through the second outlet 180 is directed to leave the vehicle through a relatively short path, to minimize the amount of head loss through the path for the flow. This arrangement also prevents any piping that directs flow from the second outlet 180 to interfere with the air flow that leaves the first outlet 121b.

The housing 110 may be formed with first and second components 120a, 120b that are fixed together and enclose and support the components of the system therewithin. The inlet 110a is formed by inlet portions of both components 120a, 120b and the outlet 121b is formed by outlet portions of both components 120a, 120b. The second outlet 180 (discussed herein) is formed within the component 120b (FIG. 4) and the piping to receive air and liquid from the second outlet 180 connects to the component 120b.

The dehumidification (also referred to as the dehumidifying component, the names are synonymous) component 130 is supported within the housing 110 and is arranged to be perpendicular to the direction of air movement through the housing (3001), and in some embodiments such that a plane 2001 through the outlet of the dehumidifying component 130 is parallel to a plane 5001 that extends through the inlet aperture 110a. In this embodiment, the plane 2001 through the outlet of the dehumidifying component 130 may also be parallel to a plane 6001 that extends through the first outlet 121b.

The dehumidification component 130 is provided to receive a flow of air therethrough, or therepast in some embodiments, and when in operation assist with removing water vapor from the air that flows into the dehumidification component 130, and specifically the portion (132, 134) of the dehumidification component that is currently in operation (discussed below). The dehumidification component 130 may be a Ceramic Humidity Regulator (CHR). The dehumidification component 130 may be a desiccant. The dehumidification component 130 may be a PTC heater. The dehumidification component 130 may include two or more of these components either placed in series (from the perspective of air flowing through or past the dehumidification component 130).

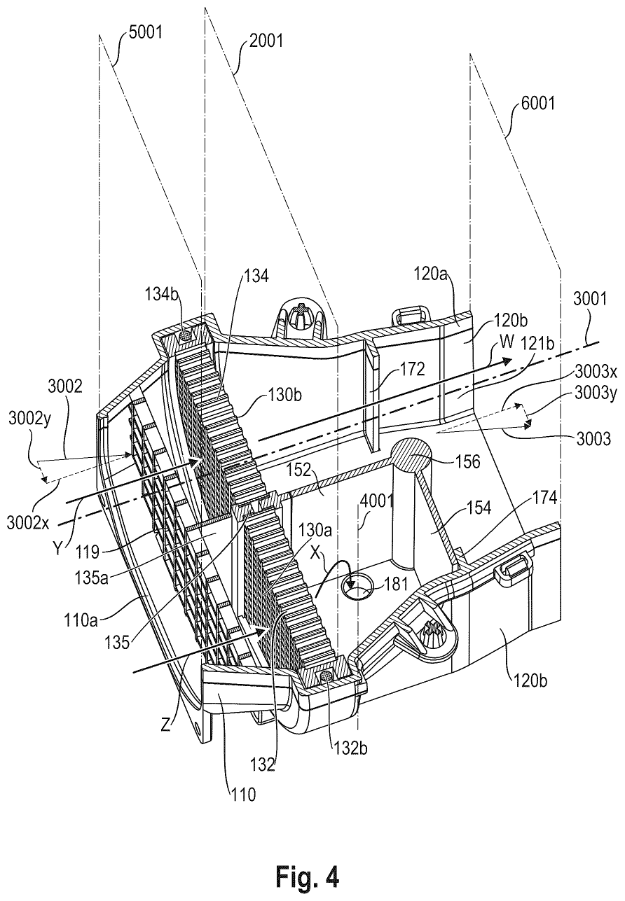

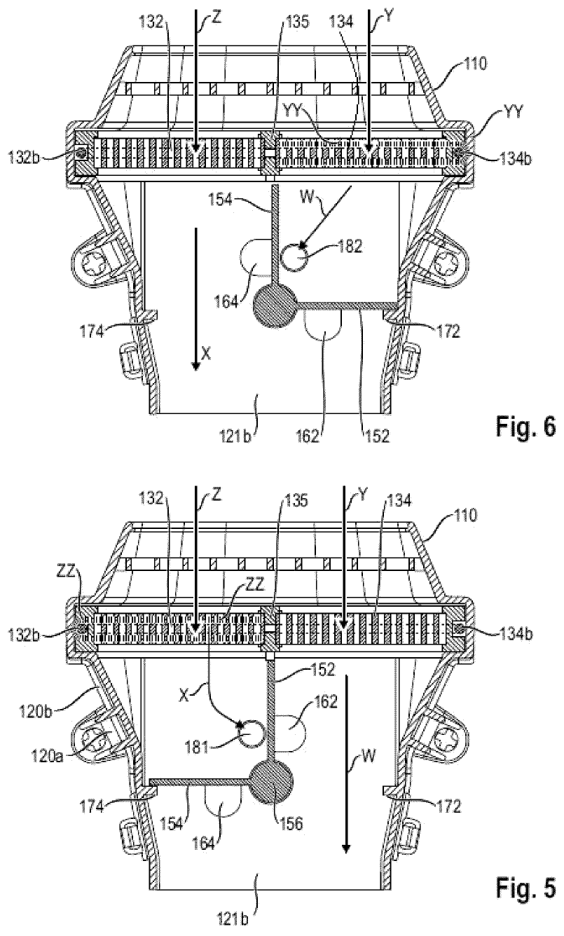

The dehumidification component 130 is best understood with reference to FIGS. 4-7. The dehumidification component 130 includes first and second portions 132, 134 that are arranged to each receive a separate flow of air therein (both from the housing inlet 110a). In a preferred embodiment, the dehumidification component 130 is round and the first portion 132 is a first semi-circle half of the component and the second portion 134 is the opposite semi-circle half of the component. When installed within the housing 110, the first portion is provided on the left side of the housing (as the housing is oriented as depicted in FIGS. 5 and 6) and the second portion 134 is provided on the right side of the housing 110. In some embodiments, a barrier 135 may be provided between the first and second portions 132, 134, with the barrier extending through the diameter of the circle, and the barrier 135 extending into and out of the page that FIGS. 5 and 6 are printed on.

In some embodiments, the barrier 135 may extend upstream of the dehumidification component 130 (portion 135a, FIG. 4) (toward the inlet aperture 110a) to separate the air that enters the inlet aperture to separate flows (flow Z to the first portion 132 and flow Y to the second portion 134), which may create more stable (less turbulent) air flow that enters the dehumidification component 130.

In a preferred embodiment, an outer circumference of the first portion 132 of the dehumidification component is provided with a heater 132b that extends around all or substantially all of the circumference of the first portion 132, and outboard of the air flow surface through the first portion 132. In this preferred embodiment, an outer circumference of the second portion 134 of the dehumidification component 130 is provided with a second heater 134b that extends around all or substantially all of the circumference of the second portion 134, and outboard of the air flow surface through the second portion 134. The heaters 132b, 134b may include respective pins or connectors 132c, 134c that receive current for operation thereof and/or control signals that control the operation (duty cycle or from a controller) of the respective heaters. The heaters maybe resistive heaters (resistive heat generation elements). The heaters may be other types of heaters that generate heat when receiving electrical current as known in the art.

The housing 110 may support a grate 119 that is disposed upstream of the dehumidification component 130 that prevents foreign objects entrained within the air from flowing to the dehumidification component 130, and prevents contact with the dehumidification component 130 by objects that extend through the housing inlet 110a. The grate 119 may be flush with an inlet surface (130a) of the dehumidification component, or may be spaced from the inlet surface 130a—as depicted in FIG. 4.

The dehumidification component 130 is operated such that in a first mode air flows through the first portion 132 and out of the housing outlet 121a, which absorbs and removes moisture/water vapor from the air that flows therethrough within the first portion 132 (FIG. 6, air flows Z and X, schematic), and in a second mode air flows through the second portion 134 and out of the housing outlet 121a, which absorbs and removes moisture/water vapor from the air that flow therethrough within the second portion 134 (FIG. 5, air flows Y, W).

Because the dehumidification component 130, with the collection of a substantial amount of moisture that has been removed (absorbed) from the air during operation over time degrades the capability of the component to remove additional moisture, the system uses at all times only one half of the dehumidification component (either portion 132 or portion 134) to remove moisture/water vapor from the air that flows into and out of the housing through the first outlet 121b, and operates in a “desorption mode” upon the other portion (the other of portions 132, 134), which removes the moisture and water vapor from that portion during the desorption mode. Specifically, in some embodiments the heater 132b/134b that surrounds the circumference of the respective portion 132/134 is energized (shown schematically as ZZ (heater 132b), and XX (heater 134b) when that portion is in desorption mode, which increases the heat within the portion and causes the moisture/water collected upon the surfaces of the portion to condense and drip/drain off of the portion and into the housing 110 (and specifically upon the lower housing portion 120b). The air continues to flow through the portion 132/134 of the dehumidification component 130 that is desorption mode, which also aids in the moisture/water leaving the surfaces of the portion under the influence of the heat produced by the energized by the respective heater 132b/134b. The air that flows through the portion that is desorption mode is prevented from flowing through the housing first outlet 121b and is instead directed to flow out of the second outlet 180, as discussed below. The term “prevent” as used herein means completely prevents as well as possibly allowing a di minimus amount of flow through the first outlet 121b such as due to improper valve seating (i.e. e.g. wing 154 upon the stop 174, discussed below), tolerance build up or wear of the components).

As can be readily understood when the first heater 132a is energized, the first portion receives an influx of heat thereon and when at the same time the second heater 134a is not energized the second portion does not receive an influx of heat thereon. The term “does not” is defined herein to include both zero heat received as well as possibly a di minimus amount of heat received (such as at portions that are close to the barrier) from the opposite operating heater (i.e. some di minimus heat from the first heater 132b may flow to portions of the second portion 134). In other words when the first heater 132a operates and the second heater 134 does not operate, the second portion does not receive a substantial influx of heat directed thereon.

In some embodiments, the operation of the system, and specifically the portion of the dehumidifying component 130 that is absorption mode and the portion of the component that is desorption mode, is controlled based upon a duty cycle, while in other embodiments, sensors may be provided to monitor the performance of the first and second dehumidification components 132, 134 and the system is operated by a controller 1000 (schematic) that uses feedback control to maximize the overall dehumidification performance of the system 100.

In embodiments where the system 100 is operated with a duty cycle, the system may for a set first time duration operate align the first portion 132 for absorption and the second portion 134 for desorption (FIG. 6) and after the completion of the first time duration align the second portion 134 for absorption and the first portion for desorption (FIG. 5) for a second time duration, and then restart the first time duration again after the completion of the first time duration, for an infinite time duration during operation of the system. In other embodiments, during the first time duration the heater 134b may only be energized for a percentage of the first time duration (and not the entire first time duration), and during the second time duration the heater 132b may only be energized for a percentage of the second time duration (and not the entire second time duration). In this embodiment, the respective heater may be operated for a first portion of the respective time duration but not be operated for a remaining portion of the respective time duration. One of ordinary skill in the art with a thorough review and understanding of this specification and a knowledge of the performance characteristics of the selected components for the dehumidification component 130 will be able to optimize the duty cycle of the first and second portions 132, 134, as well as the appropriate timing of the respective heaters 132b, 134b to obtain the desired moisture removal capability while minimizing the energy usage (by the heaters 132, 134, and fan 90 when provided) with merely routine optimization.

In other embodiments, a controller 1000 may monitor the performance (i.e. moisture removal capability, temperature, or other parameters that would be understood by one of ordinary skill in the art as representative of the performance of the system 100 upon a detailed review and understanding of this disclosure) of the first and second dehumidification portions 132, 134 and control the operation of the two portions 132, 134 (i.e. which is in absorption mode, which is in desorption mode) based upon the monitoring.

The housing 110 includes an outlet portion 120 that is downstream of the dehumidification component 130. The outlet portion 120 includes the second outlet 180 and extends to the first outlet 121b. The housing 110 supports a valve 150 that is movable between first and second positions (FIG. 5 and FIG. 6) that control the air flow in the first and second operational settings, respectively.

The second outlet 180 may include first and second apertures 182, 181 that are formed in surface of the housing 110 that allow air and liquid to flow out of the housing 110 through the second outlet 180 when the respective first and second apertures 182, 181 are exposed, and when the respective first and second aperture is covered flow through the respective aperture is blocked.

The valve 150 may include a shaft 156 that extends to an operator 190, with the operator 190 configured to adjust the position of the valve 150 based upon the operational mode within the housing 110. The operator 190 may control the valve based upon the same duty cycle as discussed above, or in embodiments where the controller 1000 controls the operation of the first and second portions 132, 134 of the dehumidification unit 130, the controller 1000 also controls the valve position to correspond to the operating portion 132, 134, as discussed below.

In other embodiments, the valve 150 may not have a central shaft as depicted in the figures, but may be controlled in other ways, such with one or more linear actuators that are directed connected to (or indirectly connected to via a transmission) the valve that control the position of the valve. One of ordinary skill in the art with a thorough review and understanding of this disclosure will readily understanding various ways to control the position of valve.

In the embodiment depicted in FIGS. 4-6, the valve 150 includes a first wing 152 and a second wing 154. The first and second wings in the embodiment depicted are aligned such that planes through the wings are perpendicular to each other. In other embodiments the first and second wings 152, 154 may be at different angles with respect to each other (such as at 60, 75 degrees, or within a range of between 60-90 degrees inclusive of all angles within the range). The wings in the depicted embodiment are planar, but in other embodiments, the wings may have curved portions or may be entirely curved. One of ordinary skill in the art with a thorough review and understanding of this specification will understand that the wings may be various sizes, shapes, and orientations, which may be dedicated by the size and shape of the outlet portion of the housing that is available for the given OEM package, and changing the size and shape and relative orientation is within the scope of this disclosure.

Each of the first and second wings 152, 154 support a blocking leg (162 upon 152, 164 upon 154). The blocking leg 162, 164 is provided to (when in the correct position) cover one of the two apertures 181, 182 that lead to the second outlet 180.

Specifically, when the first portion 132 of the dehumidifying component is in the desorption cycle, and the second portion 134 of the dehumidifying component 130 is in the absorption cycle, the valve is aligned such that the first blocking leg 162 covers the first aperture 182 but the second aperture 181 is exposed (FIG. 5). Similarly, when the second portion 134 of the dehumidifying component 130 is in the desorption cycle, the valve 150 is aligned such that the second blocking leg 164 covers the second aperture 181 but the first aperture 182 is exposed (FIG. 6).

The first and second wings 152, 154 of the valve 150 are arranged to selectively block and selectively allow air flow that leaves the dehumidification component 130 to reach the first outlet 121b.

As shown in FIG. 5, in the mode of operation where the first portion 132 of the dehumidification component 130 is in the desorption mode (i.e. to remove moisture/liquid from the surfaces of the first portion 132, as discussed above), the first and second wings 152, 154 are aligned to block air that flows from the first portion 132 (air flow X, schematic) from flowing to the first outlet 121b. The second aperture 181 of the second outlet 180 is exposed (proximate but inside of the first wing 152) and therefore air/moisture and liquid that leaves that first portion 132 flows to the second aperture 181 as schematically depicted in FIG. 5.

In this mode, the valve 150 does not block the flow from the second portion 134 of the dehumidification component 130 (air flow W, schematic) which allows that air to flow through the outlet portion 120 of the housing and to the first outlet 121b. As discussed above, in this mode, the first aperture 182 of the second outlet 180 is blocked by the first blocking leg 162, so air W does not flow into the second outlet 180.

As depicted in FIG. 6, in the mode of operation when the second portion 134 of the dehumidification component 130 is in the desorption mode (i.e. to remove moisture/liquid from the surfaces of the second portion 134, as discussed above), the first and second wings 152, 154 are aligned to block air that flows from the second portion 134 (air flow W, schematic) from flowing to the first outlet 121b. The first aperture 182 of the second outlet 180 is exposed (proximate but inside of the second wing 154) and therefore air/moisture and liquid that leaves the second portion 134 flows to the first aperture 182 as schematically depicted in FIG. 6 (flow W).

In this mode, the valve 150 does not block the flow from the first portion 132 of the dehumidification component 130 (air flow X, schematic) which allows air to flow through the outlet portion of the ho using and to the first outlet 121b. As discussed above, in this mode, the second aperture 181 of the second outlet 180 is blocked by the second blocking leg 164, so air X does not flow into the second outlet 180.

In some embodiments, the housing 110 may include respective stops 172, 174 thereupon. The stop 172 is configured to be contacted by an end of the first wing 152 when the system is in the second mode (FIG. 6) to establish the correct position of the valve 150 when in the second mode, and the stop 174 is contacted by an end of the second wing 152 when the system is in the first mode (FIG. 5) to establish the correct the correct position of the valve in the first mode.

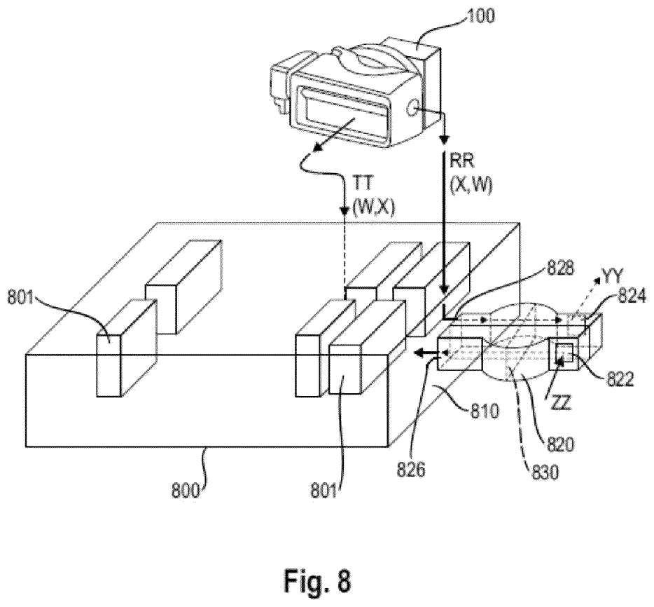

Turning now to FIGS. 8-10, the air treatment system 100 may be disposed within a sealed compartment 800, such as a battery compartment for an electric vehicle. The air treatment system 100 may be included within other compartments (than battery compartments) where moisture is desired to be removed from the air within. This embodiment will be described with respect to a sealed battery compartment for a vehicle (such as an electric vehicle) for the sake of brevity, and one of ordinary skill in the art will readily appreciate how the system 100 may be used with other types of sealed compartments in view of the teachings within this specification and without undue experimentation.

The air treatment system 100 may be operated in accordance with the system 100 discussed above, wherein at all times, one portion of the dehumidification component 130 (132, 134) is operating in the desorption mode and the other portion is operation in the absorption mode to produce dry air (flow TT, FIG. 8) that leaves the first outlet 121b of the system and flows into the battery compartment 800. During desorption mode the moist/humid air (flow RR, FIG. 8) (potentially with liquid water as well) leaves the second outlet 180 of the system and flows to an outlet housing 820 that is disposed upon an outer wall 810 of the battery compartment 800, and the air leaves the battery compartment 800 through the outlet housing 820 via flow path YY (schematic). In other embodiments, the air treatment system 100 within the battery compartment 800 is operating in desorption mode only periodically (such as when it is sensed or determined that one of the dehumidification components 132, 134 is saturated and can no longer effectively remove moisture from the air that flows through the component) to operate one of the two dehumidification components in desorption mode. In times where neither component 132, 134 is operated in desorption mode, the system when operating continues to expel air flow from the second outlet 180 that flows toward the outlet housing 820. In some embodiments, the valve 830 within the outlet housing 820 (discussed below) is shut when neither component is operating in desorption mode so that no air flows into or out of the battery compartment 800. In some embodiments, the system 100 may only be operated within the battery compartment periodically (either on a set duty cycle or as needed based upon sensed humidity levels within air within the battery compartment). In this embodiment, the inlet fan 90 associated with the housing 110 may not be operated when it is not desired to actively remove moisture from the air within the battery compartment.

FIG. 8 depicts the air treatment system 100 schematically and exploded out of the battery compartment 800. The air treatment system 100 is typically disposed within the battery compartment 800, such that the air that flows into the housing 110 (Y, Z) flows from within the battery compartment 800 and the air that leaves the first outlet 121b returns to the battery compartment 800. In some embodiments, the second outlet 180 is connected to the outlet housing 820 with a piped connection (not shown, but would extend along path RR of FIG. 8—with the air treatment system 100 properly positioned as desired within the battery compartment 800) that extends to the outer wall 810 of the battery compartment 800, through an aperture within the outer wall (aligned with the fourth opening 828 of the outlet housing) such that flow from the second outlet 180 of the air treatment system 100 flows into the fourth opening 828 and into the outlet housing 820. In other embodiments, the system 100 may be disposed within the battery compartment 800 such that the second outlet 180 is proximate to the fourth opening 828 but with no pipe therebetween. In still other embodiments, a flow guide (extends along path RR from the second outlet 180 to the aperture in the wall 810 of the battery compartment 800) may extend from the second outlet 180 of the air treatment system 100 to the fourth opening 828, which allows liquid leaving the second outlet 180 to flow to the fourth inlet 828, but allows air leaving the second outlet 180 to flow into the battery compartment and avoid flowing into the fourth opening 828.

The air treatment system 100 may be operated by a controller 1000 (which may be the same or a different controller that operates the air treatment system that is associated or within the vehicle HVAC system) to operate the first and second portions 132, 134 of the dehumidification component and the valve 150 as needed to ensure continued removal of moisture/humidity generated during operation of the battery modules (801) within the battery compartment 800. As well known, during battery operation water is created during the various chemical reactions during charge or discharge of typical batteries associated with vehicles. A high moisture content within the battery compartment may cause problems (such as shorting, corrosion, arching, or the like) within the battery compartment, especially associated with high moisture or liquid upon the battery terminals. The controller 1000 may operate the air treatment system 100 based upon a sensed humidity level within the battery compartment, or the controller 1000 may operate the air treatment system 100 with a programmed duty cycle based upon experimental determination of typical moisture creation during operation of the battery. Similarly, as discussed above, the controller 1000 may control which of the first and second portions 123, 134 is in absorption and which is in desorption with a programmed duty cycle, or with sensed parameters within the system 100 (as discussed above) that are functions of the performance or state of the first and second portions 132, 134.

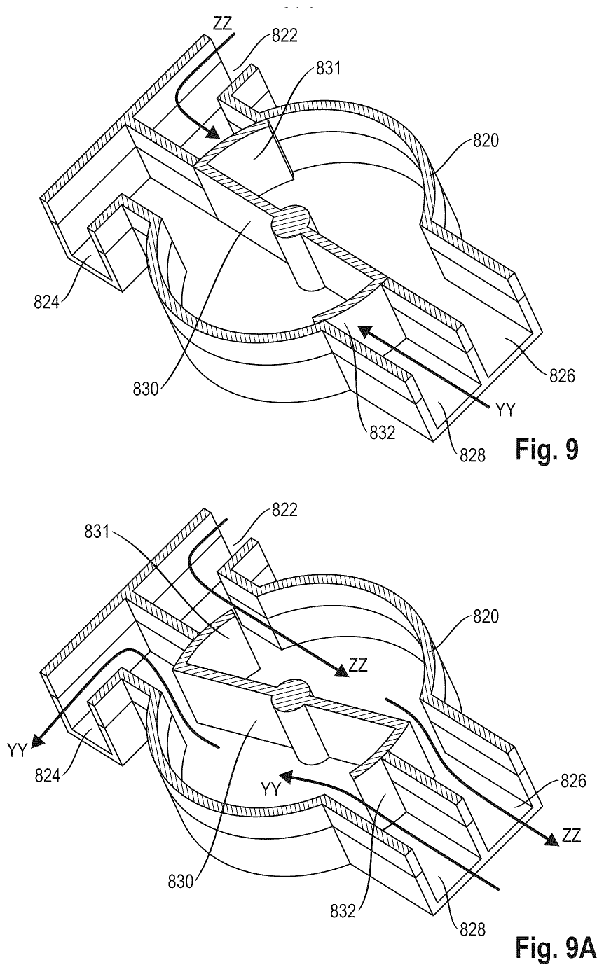

The outlet housing 820 is best shown in FIGS. 9 and 9A that are cross-sectional views of the housing 820 (shown schematically in FIG. 8). The outlet housing has first and second openings 822, 824 that are air openings to the outside environment, and third and fourth openings 826, 828 that are connected to the battery compartment wall 810—either directly, or in other embodiments connected with pipes or hoses therebetween (in embodiments where the outlet housing 820 is not physically attached to the battery compartment wall 810). The outlet housing 820 has a valve 830 that can be positioned in a closed position to prevent air flow therethrough (FIG. 9) (i.e. from the battery compartment and out of the outlet housing 820 (flow YY, schematic) and air flow from outside of the battery compartment and into the battery compartment 800 (flow ZZ, schematic), and an open position to allow air flow (FIG. 9A) both from the outside and into the battery compartment (flow ZZ) and from the battery compartment 800 and to the outside (and specifically air/liquid from the second outlet 180 of the air treatment system 100 and outside of the battery compartment 800 (flow YY).

In some embodiments, the valve 830 may be controlled by a controller (which may be the same or a different controller from the other controllers discussed herein) to be open (FIG. 9A) whenever the air treatment system 100 within the battery compartment 800 is operating and to be closed whenever the air treatment system 100 within the battery compartment 800 is not operating.

The valve 830 may have opposite valve faces (831, 832) that when in the closed position (FIG. 9), each block one of the two air flows, and when in the open position (FIG. 9A), are rotated within the housing 820 to allow flow through both flow paths (ZZ, YY).

The first opening 822 is an opening for air to enter into the outlet housing 820 and when the valve 830 is open, air flows through the third opening 826 and into the battery compartment 800 (flow ZZ). The second opening 824 is an opening for air to leave the outlet housing 820 and when the valve 830 is open air flows from the battery compartment 800 and into the outlet housing 820 through the fourth opening 828 (flow YY).

In some embodiments, the outlet housing 820 is constructed such that the first and second openings 822, 824 are located on opposite sides of the housing, and specifically with air leaving the second opening 824 in a direction opposite to a direction that air enters into the first opening 822 to minimize air that leaves the second opening 824 flowing directly to the first opening 822 and returning to the battery compartment 800.

The term “about” is specifically defined herein to include a range that includes the reference value and plus or minus 5% of the reference value. The term “substantially the same” is when the item under comparison is within 5% of the aspect of the reference value of the item and the use of “substantially” with respect to a mentioned aspect is defined as the exact aspect was well a difference from the exact aspect 5% greater than or less than the aspect.

The computing elements or functions disclosed herein, such that forms the HVAC controller 1000 or other controllers described herein, may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Representative Paragraphs:

Representative Paragraph 1: An air treatment system, comprising:
a housing comprising an air inlet, a dehumidification component, a first outlet and a second outlet each disposed to receive air that has flowed past the dehumidification component, wherein the first outlet is aligned to direct air flowing therethrough to be maintained within a vehicle that includes the housing and ultimately to a passenger compartment for the vehicle, and the second outlet is aligned to direct air flowing therethrough out of the vehicle and not into the passenger compartment;
the dehumidification component configured to receive electric current during operation;
the dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon;
further comprising a valve that directs air received from the dehumidification component to either the first or the second outlet.

Representative Paragraph 2: The air treatment system of Representative Paragraph 1, wherein the valve is configured to be in a first position in the first operational setting, and a second position in the second operational setting, wherein in the first position, air that flows from the first portion of the dehumidification component flows to the second outlet and air that flows from the second portion of the dehumidification component flows to the first outlet,
wherein when the valve is in the second position air that flows from the second portion of the dehumidification component flows to the second outlet and air that flows from the first portion of the dehumidification component flows to the first outlet.

Representative Paragraph 3: The air treatment system of Representative Paragraph 2, wherein the housing includes first and second apertures that each flow to the second outlet, wherein the valve comprises a blocking leg that can be aligned to block one of the first and second apertures and allow flow through the other of the first and second apertures.

Representative Paragraph 4: The air treatment system of Representative Paragraph 3, wherein the blocking leg is a first blocking leg and a second blocking leg, wherein when the valve is in the first position, the first blocking leg blocks flow through the first aperture and the second blocking leg is not aligned with any aperture, and when the valve is in the second position the second blocking leg blocks flow through the second aperture and the first blocking leg is not aligned with any aperture.

Representative Paragraph 5: The air treatment system of Representative Paragraph 4, wherein the valve comprises a first wing and a second wing wherein the first and second wings are each planar with the respective first and second blocking leg extending substantially perpendicularly from the respective planar wing,
wherein when the valve is in the first position the first wing and the second wing are each aligned within the housing to prevent air that flows from the first portion of the dehumidification component from flowing to the first outlet;
wherein when the valve is in the second position, the first wing and the second wing are each aligned within the housing to prevent air that flows from the second portion of the dehumidification component from flowing to the first outlet.

Representative Paragraph 6: The air treatment system of Representative Paragraph 5, wherein when the valve is in the first position, the first wing is aligned within the housing such that the first wing is substantially perpendicular to a plane through an outlet surface of the dehumidification component and the second wing is substantially parallel to plane through the outlet surface of the dehumidification component.

Representative Paragraph 7: The air treatment system of Representative Paragraph 6, wherein the first and second blocking legs are disposed substantially perpendicular to the plane through the outlet surface of the dehumidification component.

Representative Paragraph 8: The air treatment system of any one of Representative Paragraphs 2-7, wherein the valve rotates substantially 90 degrees when rotating between the first and second positions.

Representative Paragraph 9: The air treatment system of any one of the preceding Representative Paragraphs, wherein the housing further comprises a divider disposed proximate to an inlet surface of the dehumidification component, wherein the divider separates air that flows into the dehumidification component into respective first and second streams before air reaches the dehumidification component.

Representative Paragraph 10: The air treatment system of any one of the preceding Representative Paragraphs, wherein the dehumidification component is a PTC heater.

Representative Paragraph 11: The air treatment system of any one of Representative Paragraphs 1-9, wherein the dehumidification component is a desiccant.

Representative Paragraph 12: The air treatment system of any one of Representative Paragraphs 1-9, wherein the dehumidification component is a ceramic humidity regulator.

Representative Paragraph 13: The air treatment system of any one of the preceding Representative Paragraphs, wherein the housing is configured to be disposed such that air that flows into the air inlet flows from the passenger compartment of the vehicle.

Representative Paragraph 14: The air treatment system of Representative Paragraph 13, wherein the housing directs condensed water vapor from the dehumidification component to flow out of the second outlet.

Representative Paragraph 15: The air treatment system of any one of the preceding Representative Paragraphs, wherein a controller coordinates a generation of heat flux that is directed into the respective first and second portions depending upon the respective first and second operational setting.

Representative Paragraph 16: The air treatment system of any one of Representative Paragraphs 1-14, wherein an outer circumference of the first portion of the dehumidification component is surrounded by a first resistive heat generation element and an outer circumference of the second portion of the dehumidification component is surrounded by a second resistive heat generation element, wherein energizing the respective first or second heat generation element generates the influx of heat directed toward the respective first and second portion of the dehumidification component.

Representative Paragraph 17: The air treatment system of Representative Paragraph 16, wherein the first resistive heat generation element and the second resistive heat generation element are both operated on opposite respective first and second duty cycles, such that when the first resistive heat generation element is energized the second resistive heat generation element is deenergized, and when the second resistive heat generation element is energized the first resistive heat generation element is deenergized.

Representative Paragraph 18: The air treatment system of Representative Paragraph 17, wherein the first and second opposite duty cycles are constant, and are each the same duration.

Representative Paragraph 19: The air treatment system of Representative Paragraph 16, comprising first and second humidity sensors that are disposed downstream of the dehumidification component and in line with the respective first and second portions of the dehumidification component, wherein a controller receives signals that are proportional to a moisture content from each of the first and second humidity sensors, and aligns the valve to the respective first or second operational setting based upon the measured humidity from each of the first and second humidity sensors.

Representative Paragraph 20: The air treatment system of any one of the preceding Representative Paragraphs, wherein the air treatment system is disposed within an HVAC system of a vehicle, wherein the air treatment system is disposed such that air that flows from a passenger compartment of a vehicle toward an inlet aperture within the HVAC system flows through the housing and out of the first outlet before flowing to a blower of the HVAC system.

Representative Paragraph 21: The air treatment system of Representative Paragraph 20, wherein the air treatment is disposed proximate to an inlet aperture within an air inlet housing within the HVAC system within the vehicle, such that air that flows out of the first outlet flows into the inlet aperture of the air inlet housing within the HVAC system.

Representative Paragraph 22: The air treatment system of any one of Representative Paragraphs 1-19, wherein the air treatment system is disposed within a sealed battery compartment within a vehicle, wherein the first outlet is aligned to direct air into the sealed battery compartment and the second outlet is aligned such that flow therethrough is directed toward or to an outlet of the sealed battery compartment.

Representative Paragraph 23: The air treatment system of Representative Paragraph 22, further comprising an outlet housing that is disposed in fluid communication with the sealed battery compartment, wherein the outlet housing has a valve that can be positioned to allow air flow into and out of the sealed battery compartment and the valve can be positioned to prevent air flow into and out of the sealed battery compartment.

Representative Paragraph 24: An air treatment system for use within a sealed compartment, comprising:
a sealed compartment that is configured to receive one or more batteries therein;
a housing that is disposed within the sealed compartment, the housing comprising an air inlet, a dehumidification component, a first outlet and a second outlet each disposed to receive air that has flowed past the dehumidification component, wherein the first outlet is aligned to direct air flowing therethrough to be maintained within the sealed compartment that includes the housing, and the second outlet is aligned to direct air flowing therethrough out of sealed compartment;
the dehumidification component configured to receive electric current during operation;
the dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon;
further comprising a valve that directs air received from the dehumidification component to either the first or the second outlet.

Representative Paragraph 25: The air treatment system of Representative Paragraph 24, wherein the valve is configured to be in a first position in the first operational setting, and a second position in the second operational setting, wherein in the first position, air that flows from the first portion of the dehumidification component flows to the second outlet and air that flows from the second portion of the dehumidification component flows to the first outlet,
wherein when the valve is in the second position air that flows from the second portion of the dehumidification component flows to the second outlet and air that flows from the first portion of the dehumidification component flows to the first outlet.

Representative Paragraph 26: The air treatment system of Representative Paragraph 25, wherein the housing includes first and second apertures that each flow to the second outlet, wherein the valve comprises a blocking leg that can be aligned to block one of the first and second apertures and allow flow through the other of the first and second apertures.

Representative Paragraph 27: The air treatment system of Representative Paragraph 26, wherein the blocking leg is a first blocking leg and a second blocking leg, wherein when the valve is in the first position, the first blocking leg blocks flow through the first aperture and the second blocking leg is not aligned with any aperture, and when the valve is in the second position the second blocking leg blocks flow through the second aperture and the first blocking leg is not aligned with any aperture.

Representative Paragraph 28: The air treatment system of Representative Paragraph 27, wherein the valve comprises a first wing and a second wing wherein the first and second wings are each planar with the respective first and second blocking leg extending substantially perpendicularly from the respective planar wing,
wherein when the valve is in the first position the first wing and the second wing are each aligned within the housing to prevent air that flows from the first portion of the dehumidification component from flowing to the first outlet;
wherein when the valve is in the second position, the first wing and the second wing are each aligned within the housing to prevent air that flows from the second portion of the dehumidification component from flowing to the first outlet.

Representative Paragraph 29: The air treatment system of Representative Paragraph 28, wherein when the valve is in the first position, the first wing is aligned within the housing such that the first wing is substantially perpendicular to a plane through an outlet surface of the dehumidification component and the second wing is substantially parallel to plane through the outlet surface of the dehumidification component.

Representative Paragraph 30: The air treatment system of Representative Paragraph 29, wherein the first and second blocking legs are disposed substantially perpendicular to the plane through the outlet surface of the dehumidification component.

Representative Paragraph 31: The air treatment system of any one of Representative Paragraphs 25-29, wherein the valve rotates substantially 90 degrees when rotating between the first and second positions.

Representative Paragraph 31: The air treatment system of any one of Representative Paragraphs 24-30, wherein the housing further comprises a divider disposed proximate to an inlet surface of the dehumidification component, wherein the divider separates air that flows into the dehumidification component into respective first and second streams before air reaches the dehumidification component.

Representative Paragraph 33: The air treatment system of any one of Representative Paragraphs 24-31, wherein the dehumidification component is a PTC heater.

Representative Paragraph 34: The air treatment system of any one of Representative Paragraphs 24-31, wherein the dehumidification component is a desiccant.

Representative Paragraph 35: The air treatment system of any one of Representative Paragraphs 24-31, wherein the dehumidification component is a ceramic humidity regulator.

Representative Paragraph 36: The air treatment system of any one of Representative Paragraphs 24-34, wherein the housing is configured to be disposed such that air that flows into the air inlet flows from the sealed compartment.

Representative Paragraph 37: The air treatment system of Representative Paragraph 36, wherein the housing directs condensed water vapor from the dehumidification component to flow out of the second outlet.

Representative Paragraph 38: The air treatment system of any one of Representative Paragraphs 24-37, wherein a controller coordinates a generation of heat flux that is directed into the respective first and second portions depending upon the respective first and second operational setting.

Representative Paragraph 39: The air treatment system of any one of Representative Paragraphs 24-38, wherein an outer circumference of the first portion of the dehumidification component is surrounded by a first resistive heat generation element and an outer circumference of the second portion of the dehumidification component is surrounded by a second resistive heat generation element, wherein energizing the respective first or second heat generation element generates the influx of heat directed toward the respective first and second portion of the dehumidification component.

Representative Paragraph 40: The air treatment system of Representative Paragraph 39, wherein the first resistive heat generation element and the second resistive heat generation element are both operated on opposite respective first and second duty cycles, such that when the first resistive heat generation element is energized the second resistive heat generation element is deenergized, and when the second resistive heat generation element is energized the first resistive heat generation element is deenergized.

Representative Paragraph 41: The air treatment system of Representative Paragraph 40, wherein the first and second opposite duty cycles are constant, and are each the same duration.

Representative Paragraph 42: The air treatment system of Representative Paragraph 39, comprising first and second humidity sensors that are disposed downstream of the dehumidification component and in line with the respective first and second portions of the dehumidification component, wherein a controller receives signals that are proportional to a moisture content from each of the first and second humidity sensors, and aligns the valve to the respective first or second operational setting based upon the measured humidity from each of the first and second humidity sensors.

Representative Paragraph 43: The air treatment system of any one of Representative Paragraphs 24-42, further comprising an outlet housing that is disposed in fluid communication with the sealed compartment, wherein the outlet housing has a valve that can be positioned to allow air flow into and out of the sealed compartment and the valve can be positioned to prevent air flow into and out of the sealed compartment.

1. An air treatment system, comprising:
a housing comprising an air inlet, a dehumidification component, a first outlet and a second outlet each disposed to receive air that has flowed past the dehumidification component, wherein the first outlet is aligned to direct air flowing therethrough to be maintained within a vehicle that includes the housing and ultimately to a passenger compartment for the vehicle, and the second outlet is aligned to direct air flowing therethrough out of the vehicle and not into the passenger compartment;
the dehumidification component configured to receive electric current during operation;
the dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon;
further comprising a valve that directs air received from the dehumidification component to either the first or the second outlet.

2. The air treatment system of claim 1, wherein the valve is configured to be in a first position in the first operational setting, and a second position in the second operational setting, wherein in the first position, air that flows from the first portion of the dehumidification component flows to the second outlet and air that flows from the second portion of the dehumidification component flows to the first outlet,
wherein when the valve is in the second position air that flows from the second portion of the dehumidification component flows to the second outlet and air that flows from the first portion of the dehumidification component flows to the first outlet.

3. The air treatment system of claim 2, wherein the housing includes first and second apertures that each flow to the second outlet, wherein the valve comprises a blocking leg that can be aligned to block one of the first and second apertures and allow flow through the other of the first and second apertures.

4. The air treatment system of claim 3, wherein the blocking leg is a first blocking leg and a second blocking leg, wherein when the valve is in the first position, the first blocking leg blocks flow through the first aperture and the second blocking leg is not aligned with any aperture, and when the valve is in the second position the second blocking leg blocks flow through the second aperture and the first blocking leg is not aligned with any aperture.

5. The air treatment system of claim 4, wherein the valve comprises a first wing and a second wing wherein the first and second wings are each planar with the respective first and second blocking leg extending substantially perpendicularly from the respective planar wing,
wherein when the valve is in the first position the first wing and the second wing are each aligned within the housing to prevent air that flows from the first portion of the dehumidification component from flowing to the first outlet;
wherein when the valve is in the second position, the first wing and the second wing are each aligned within the housing to prevent air that flows from the second portion of the dehumidification component from flowing to the first outlet.

6. The air treatment system of claim 5, wherein when the valve is in the first position, the first wing is aligned within the housing such that the first wing is substantially perpendicular to a plane through an outlet surface of the dehumidification component and the second wing is substantially parallel to plane through the outlet surface of the dehumidification component.

7. The air treatment system of claim 6, wherein the first and second blocking legs are disposed substantially perpendicular to the plane through the outlet surface of the dehumidification component.

8. The air treatment system of claim 2, wherein the valve rotates substantially 90 degrees when rotating between the first and second positions.

9. The air treatment system of claim 1, wherein the housing further comprises a divider disposed proximate to an inlet surface of the dehumidification component, wherein the divider separates air that flows into the dehumidification component into respective first and second streams before air reaches the dehumidification component.

10. The air treatment system of claim 1, wherein the dehumidification component is a PTC heater.

11. The air treatment system of claim 1, wherein the dehumidification component is a desiccant.

12. The air treatment system of claim 1, wherein the dehumidification component is a ceramic humidity regulator.

13. The air treatment system of claim 1, wherein the housing is configured to be disposed such that air that flows into the air inlet flows from the passenger compartment of the vehicle.

14. The air treatment system of claim 13, wherein the housing directs condensed water vapor from the dehumidification component to flow out of the second outlet.

15. The air treatment system of claim 1, wherein a controller coordinates a generation of heat flux that is directed into the respective first and second portions depending upon the respective first and second operational setting.

16. The air treatment system of claim 1, wherein an outer circumference of the first portion of the dehumidification component is surrounded by a first resistive heat generation element and an outer circumference of the second portion of the dehumidification component is surrounded by a second resistive heat generation element, wherein energizing the respective first or second heat generation element generates the influx of heat directed toward the respective first and second portion of the dehumidification component.

17. The air treatment system of claim 16, wherein the first resistive heat generation element and the second resistive heat generation element are both operated on opposite respective first and second duty cycles, such that when the first resistive heat generation element is energized the second resistive heat generation element is deenergized, and when the second resistive heat generation element is energized the first resistive heat generation element is deenergized.

18. The air treatment system of claim 17, wherein the first and second opposite duty cycles are constant, and are each the same duration.

19. The air treatment system of claim 16, comprising first and second humidity sensors that are disposed downstream of the dehumidification component and in line with the respective first and second portions of the dehumidification component, wherein a controller receives signals that are proportional to a moisture content from each of the first and second humidity sensors, and aligns the valve to the respective first or second operational setting based upon the measured humidity from each of the first and second humidity sensors.

20. The air treatment system of claim 1, wherein the air treatment system is disposed within an HVAC system of a vehicle, wherein the air treatment system is disposed such that air that flows from a passenger compartment of a vehicle toward an inlet aperture within the HVAC system flows through the housing and out of the first outlet before flowing to a blower of the HVAC system.

21. The air treatment system of claim 20, wherein the air treatment is disposed proximate to an inlet aperture within an air inlet housing within the HVAC system within the vehicle, such that air that flows out of the first outlet flows into the inlet aperture of the air inlet housing within the HVAC system.

22. An air treatment system for use within a sealed compartment, comprising:
a sealed compartment that is configured to receive one or more batteries therein;
a housing that is disposed within the sealed compartment, the housing comprising an air inlet, a dehumidification component, a first outlet and a second outlet each disposed to receive air that has flowed past the dehumidification component, wherein the first outlet is aligned to direct air flowing therethrough to be maintained within the sealed compartment that includes the housing, and the second outlet is aligned to direct air flowing therethrough out of sealed compartment;
the dehumidification component configured to receive electric current during operation;
the dehumidification component includes first and second portions that are operable to sequentially receive electric current such that in a first operational setting the first portion receives an influx of heat directed thereto and the second portion does not receive an influx of heat directed thereon, and in a second operational setting the second portion receives an influx of heat directed thereto and the first portion does not receive an influx of heat directed thereon;
further comprising a valve that directs air received from the dehumidification component to either the first or the second outlet.

23. The air treatment system of claim 22, further comprising an outlet housing that is disposed in fluid communication with the sealed compartment, wherein the outlet housing has a valve that can be positioned to allow air flow into and out of the sealed compartment and the valve can be positioned to prevent air flow into and out of the sealed compartment.
